(19) United States
(12) Patent Application Publication
(10) Pub. No.: US 2014/0255143 A1
(43) Pub. Date: Sep. 11, 2014

(54) Controller Configured to Control Power from Source to Drain

(71) Applicant: Joel Stave, Spencer, IA (US)

(72) Inventor: Joel Stave, Spencer, IA (US)

(21) Appl. No.: 13/790,385

(22) Filed: Mar. 8, 2013

(51) Int. Cl. B60R 16/03; B65G 67/24

(52) U.S. Cl. CPC B60R 16/03; B65G 67/24
USPC 414/812; 307/116; 307/9.1

(57) ABSTRACT

Disclosed is a controller configured to control a flow of current from a source to a drain. The controller may be equipped with a receiver. Thus, the control of electricity may be controlled remotely. Disclosed also is a system that includes a power source, a drain, and a controller connecting the power source to the drain. The power source may be configured to receive a signal which enables the controller to at least one of allow power to flow from the power source to drain or prevent power from flowing from the power source to the drain. Disclosed also is a transporting device that uses the controller and a method that uses the controller.

### BACKGROUND

1. Field

Example embodiments are directed to controllers configured to regulate power flowing from a source to a drain. Example embodiments are also directed to systems that include the controllers, and methods that use the controllers.

2. Description of the Related Art

Grains and certain types of animal feed are often transported from one location to another by a tractor-trailer. The trailer often includes equipment, such as belts, augers, and motors, that are used to unload the grain or animal feed from the trailer. This equipment is often powered by the tractor. For example, tractors typically have a pin trailer connector (for example, a seven way round pin connector) to which electrical cables from the trailer attach. The cables allow power (in the form of electricity) to flow from the tractor to the equipment of the trailer.

In the conventional art, an operator often drives a load of animal feed or grain to a site having a plurality of bins. Each bin, however, may store a specific type of animal feed or grain. Thus, the driver must make sure he delivers the load to the correct bin before unloading the load into the bin. In the event the driver makes a mistake, the load may be deposited into an incorrect bin which may not only ruin the load he delivered, but any existing grain or animal feed that may be present in the bin.

### SUMMARY

Example embodiments are directed to controllers configured to regulate power flowing from a source to a drain. Example embodiments are also directed to systems that include the controllers, and methods that use the controllers.

In accordance with example embodiments, a controller may include a receiver configured to receive a signal from an external source and a circuit configured to allow power to flow from a source to a drain based on the signal.

In accordance with example embodiments, a system may include a power source, a drain, and a controller connecting the power source to the drain. In example embodiments, the controller may be configured to receive a signal to at least one of: a) allow power to flow from the power source to the drain; and b) prevent power from flowing from the power source to the drain.

In accordance with example embodiments, a system may include a transporting device including a vehicle, a trailer, and a controller configured to control power flowing from the vehicle to equipment associated with the trailer based on a signal transmitted from an external source.

In accordance with example embodiments, a method of delivering a material may include arranging a transporting device near a bin. The transporting device may include a vehicle, a trailer holding the material, and a controller configured to control power flowing from the vehicle to equipment associated with the trailer. The method may further include transmitting a signal from an external device to the controller, wherein the controller controls the power flowing from the vehicle to the equipment based on the signal transmitted from the external device.

### BRIEF DESCRIPTION OF THE DRAWINGS

Example embodiments are described in detail below with reference to the attached figures, wherein:

FIGS. 1A and 1B are schematic views of a controller in accordance with example embodiments;

FIG. 2 is a schematic drawing of a power system in accordance with example embodiments;

FIG. 3 is a schematic drawing of a system in accordance with example embodiments;

FIG. 4 is a schematic drawing of a system in accordance with example embodiments;

FIG. 5 is a schematic drawing of a system in accordance with example embodiments;

FIG. 6 is a schematic drawing of a power system in accordance with example embodiments;

FIGS. 7A and 7B are schematic views of a controller in accordance with example embodiments; and

FIG. 8 is a schematic drawing of a system in accordance with example embodiments.

### DETAILED DESCRIPTION

Example embodiments of the invention will now be described with reference to the accompanying drawings. Example embodiments, however, should not be construed as limiting the invention since the invention may be embodied in different forms. Example embodiments illustrated in the figures are provided so that this disclosure will be thorough and complete. In the drawings, the sizes of components may be exaggerated for clarity.

In this application, when an element is referred to as being “on,” “attached to,” “connected to,” or “coupled to” another element, it can be directly on, attached to, connected to, or coupled to the other element or intervening elements that may be present. On the other hand, when an element is referred to as being “directly on,” “directly attached to,” “directly connected to,” or “directly coupled to” another element, there are no intervening elements present. As used herein, the term “and/or” includes any and all combinations of one or more of the associated listed items.

In this application, the terms first, second, etc. are used to describe various elements, components, regions, layers, and/or sections. However, these elements, components, regions, layers, and/or sections should not be limited by these terms since these terms are only used to distinguish one element, component, region, layer, and/or section from other elements, components, regions, layers, and/or sections that may be present. For example, a first element, component region, layer or section discussed below could be termed a second element, component, region, layer, or section.

In this application, spatial terms, such as “beneath,” “below,” “lower,” “over,” “above,” and “upper” (and the like) are used for ease of description to describe one element or feature's relationship to another element(s) or feature(s). The invention, however, is not intended to be limited by these spatial terms. For example, if an example of the invention illustrated in the figures is turned over, elements described as “over” or “above” other elements or features would then be oriented “under” or “below” the other elements or features. Thus, the spatial term “over” may encompass both an orientation of above and below. The device may be otherwise oriented (for example, rotated 45 degrees, 90 degrees, 180 degrees, or at other orientations) and the spatially relative descriptors used herein interpreted accordingly.

In this application, example embodiments may be described by referring to plan views and/or cross-sectional views which may be ideal schematic views. However, it is understood the views may be modified depending on manufacturing technologies and/or tolerances. Accordingly, the invention is not limited by the examples illustrated in the views, but may include modifications in configurations formed on the basis of manufacturing process. Therefore, regions illustrated in the figures are schematic and exemplary and do not limit the invention.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments are directed to controllers configured to regulate power that may flow from a source to a drain. Example embodiments are also directed to systems that include the controllers, and methods that use the controllers.

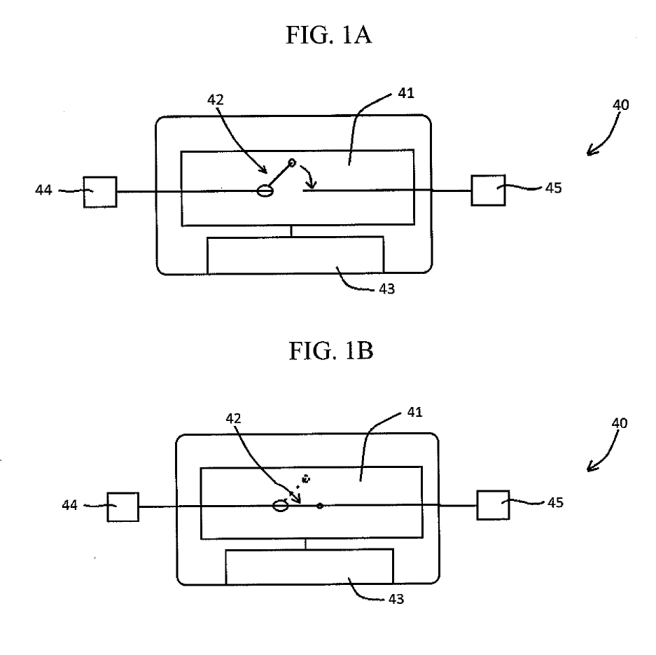

FIGS. 1A and 1B are views of a power controller 40 in accordance with example embodiments. In example embodiments, the power controller 40 may include a receiver 43 and an electrical circuit 41. The electrical circuit 41 may, for example, be part of a computer processor or connected to a computer processor. The receiver 43 may be configured to receive a signal from an external source, for example, a transmitter or GPS locater.

In example embodiments, the electrical circuit 41 may include a switch 42 which may be in an open position, as illustrated in FIG. 1A, or a closed position, as illustrated in FIG. 1B. In example embodiments, the electrical circuit 41 may be connected to the receiver 43 and the switch 42 may be open or closed depending on a signal that is received by the receiver 43. For example, the circuit 41 of the controller 40 may be configured so that the switch 42 will move from an open state (as shown in FIG. 1A) to a closed state (as shown in FIG. 1B) in the event the receiver 43 receives a signal from an external source, wherein the external source may be a GPS locator and the controller 41 may compare the GPS location of the circuit 41 to that of the intended bin to determine whether the switch 42 should be closed or open. Thus, in example embodiments, power (electrical current) may flow through the controller 40 in response to the receiver 43 receiving a signal. Example embodiments, however, are not limited thereto. For example, in example embodiments, the circuit 41 of the controller 40 may be configured so that the switch 42 will move from a closed state (as shown in FIG. 1B) to an open state (as shown in FIG. 1A) in the event the receiver 43 receives a signal from an external source. Thus, in example embodiments, power (electrical current) may be prevented from flowing through the controller 40 in response to the receiver 43 receiving a signal.

In example embodiments, the controller 40 may include a first connector 44 and a second connector 45. In example embodiments, the first connector 44 and the second connector 45 may be electrically connected to each other by the circuit 41. In example embodiments, the first connector 44 may be configured to attach to a power source, for example, an electrical system of a vehicle, and the second connector 45 may be configured to attach to a drain, for example, equipment, such as belts, augers, and motors, that may be on a trailer. Thus, the controller 40 may control whether or not power may flow from the source (for example, a vehicle) to the drain (for example, equipment on a trailer). For example, in the event the switch 42 is open, power may be prevented from flowing from the source to the drain. On the other hand, if the switch 42 is closed, power may flow from the source to the drain. Because the switch 42 may be controlled by a signal received by the receiver 43, and the signal may be sent from a remote location, power flowing from the source to the drain may be controlled remotely.

In example embodiments, the first connector 44 may be a male type socket which may be configured to plug into a power source, for example, a pin trailer connector (for example, a seven way round pin connector) that is found on conventional tractors (an example of a vehicle as well as an example of a power source). The second connector 45 may be also be a male type socket which may be configured to attach to a drain, for example, a cable having a male type socket electrically connected to equipment that may be on trailer. In the case where the truck and trailer have the same socket, and the in-line controller device include both a male and a female connection, a connector comprising two female ends may be employed to complete the circuit. Thus, the controller 40 may be easily installed in conventional tractor/trailers. The instant features, however, are not intended to limit the invention. For example, the first connector 44 may be a male type socket and the second connector 45 may be a female type socket. As another example, the first connector 44 and the second connector 45 may not be sockets but may be conductive members (for example, wires) that may be spliced into an existing electrical cable. Furthermore, the power controller 40 is not limited to being used with a tractor-trailer as the power controller 40 may be used to control power flowing from any source to any drain.

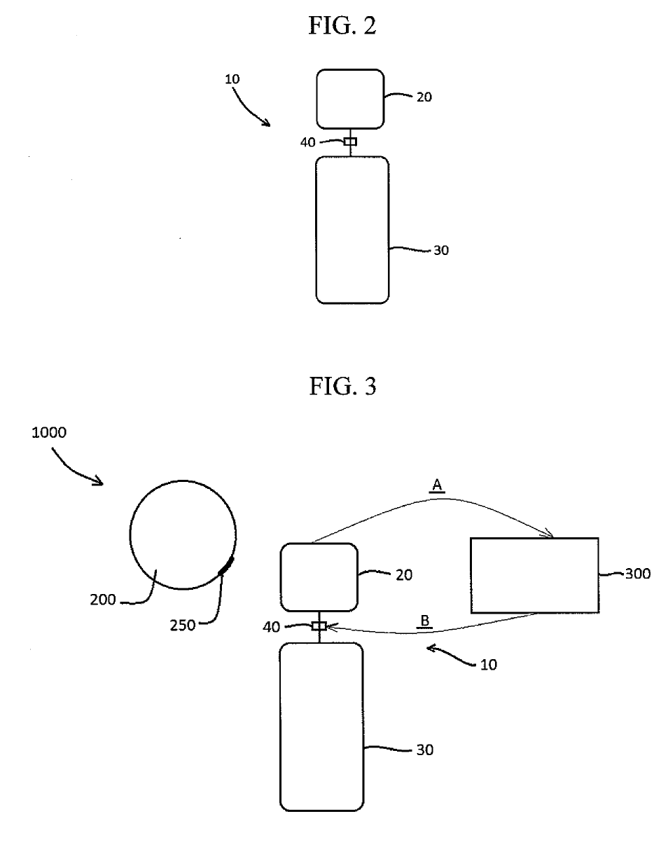

FIG. 2 is an example of a power system 10 using the power controller 40 in accordance with example embodiments. As shown in FIG. 2, the power system 10 may include a power source 20, a drain 30, and the power controller 40 between the power source 20 and the drain 30. In example embodiments, the power source 20 may be part of a vehicle, for example, a truck, and the drain 30 may be part of a trailer, for example a feed unload trailer. More specifically, the power source 20 may be part of an electrical system of a truck and the drain 30 may be a device associated with a trailer that consumes power provided by the electrical system. For example, the drain 30 may be a belt, an auger, a motor, and/or lights that may be part of a feed unload trailer. In example embodiments, the source 20, the drain 30, and the controller 40 may constitute a transporting device since the source 20 may be a vehicle and the drain 30 may be a trailer. Although examples of the drain 30 have been provided, the examples are not intended to limit example embodiments since the drain 30 may be any device that consumes power.

In example embodiments, and as described above, the power controller 40 may be a wireless device configured to receive a signal from a transmitter. As explained, the power controller 40 may use the signal to regulate power flowing from the power source 20 to the drain 30. For example, the power controller 40 may be configured to receive a signal from an external device and use that signal to prevent power from flowing from the power source 20 to the drain 30. In the alternative, the power controller 40 may be configured to receive a signal to allow power to flow from the power source 20 to the drain 30. In example embodiments, the controller 40 may be configured to utilize both types of signals. For example, the controller 40 may be configured to receive a power enabling signal that closes the switch 42 of the controller 40 to allow power to pass through the controller and/or a power disabling signal that opens the switch 42 of the controller 40 to prevent power from flowing through the controller.

As mentioned above, tractors often include a pin trailer connector (for example, a seven way round pin connector) to which an electrical system of trailer may attach. Conventional trailers use power provided by the tractor to energize various components thereof, for example, motors, belts, augers, and lights. In example embodiments, the power controller 40 may be interposed between the electrical system of the trailer and the tractor. For example, one end of the power controller 40 may attach to the pin trailer connector of a tractor (an example of the power source 20) and another end of the power controller 40 may attach to the electrical system of the trailer (an example of the drain 30). Thus, the power controller 40 may be interposed between the power source 20 and the electrical system of the trailer 30. Installation of the power controller 40 may be facilitated by forming the first connector 44 to attach to an existing connector (for example pin connector) of the tractor and by forming the second connector 45 to attach to a cable of the trailer's electrical system. In this way, the power controller 40 may plug into, via the first and second connectors 44 and 45, the electrical systems of the trailer and tractor in order to regulate power between the trailer and the tractor. Accordingly, the power controller 40 may be provided as an adapter and thus may be easily transferred from one tractor/trailer to another. If in the event a driver of the tractor/trailer tries to remove the power controller 40 when the power has been interrupted by the management system the power controller 40 or the management center 300 (see paragraph 32) will log the following. Date time power was disconnected and reconnected, and location.

In the alternative, conventional cables connecting the electrical system of a tractor to an electrical system of a trailer may be spliced and the power controller 40 may be connected to the spliced ends of the cables.

FIG. 3 is view of a system 1000 using the power system 10 in accordance with example embodiments. As shown in FIG. 3, the system 1000 includes the power source 20, the drain 30, and the power controller 40. In this particular nonlimiting example, the power source 20 may be part of a tractor, the drain 30 may be part of a trailer, and the power controller 40 may be between the tractor and the trailer and may control power flowing from the tractor to the trailer. In example embodiments, the example system 1000 may further include a bin 200 and a management center 300. In example embodiments, the bin 200 may be, but is not limited to, a grain bin and the management center 300 may be, but is not limited to, a grain management center. In example embodiments, the management center 300 may include a computer system configured to receive and transmit a signal. For example, the management center 300 may be configured to send a signal to the power controller 40 to prevent (or allow) power from flowing from the power source 20 to the drain 30.

In example embodiments the bin 200 may be an empty bin or a partially filled bin and may be ready for receiving a material, for example, grain. On the other hand, the bin may include material, for example, grain, which may be unloaded into a transportation device, such as a trailer. In example embodiments, the bin 200 may include an identification mark 250 and the user may use the mark to identify the bin 200. For example, a user may read the identification mark 250 and send a signal A to the management system 300, for example, by a computer, a cell phone, or a PDA, indicating which bin the user is at. In the event the user is at a correct bin, the management system 300 may send a signal B to the controller 40 to allow the power to flow from the power source 20 to the drain 30 so that the equipment on the drain 30, for example, augers, belts, and motors, may be operated.

A particularly useful nonlimiting embodiment of the system 1000 may be employed at sites with multiple bins wherein a specific load is to be delivered to a specific bin. In this particular nonlimiting example, a driver may drive a tractor/trailer (an example of a power source 20 and the drain 30) having a controller 40 therein to a site with the multiple bins. Data regarding the specific load, for example, a type, blend, or quality of grain, may be provided to a grain management system (an example of the management system 300) either before the specific load is loaded into the trailer, as the specific load is being loaded onto the trailer, or after the specific load is loaded onto the trailer. The grain management system or another user may then determine which bin the specific load is to be delivered to.

In this particular nonlimiting example, the driver may transport the specific load to the site having the multiple bins and arrange the tractor/trailer near a specific bin which the driver believes is the specific bin to which the specific load is to be delivered. The driver may then read an identification mark of the bin (an example of the identification mark 250) and place a call or send a signal to the grain management center. If the driver is at the correct bin, the grain management center may send a signal to the controller 40 to allow power to flow from the tractor to equipment on the trailer (for example, motors, belts, and augers) to allow the driver to deliver the specific load to the identified bin. In the event the grain management center determines the driver is at the wrong bin, the grain management center would either send a signal to controller 40 to prevent power from flowing from the tractor to the equipment on the trailer to prevent the specific load from being placed in the incorrect bin or would not send a signal that enables power to be sent from the tractor to the trailer. In either case, the cooperation of the grain management center and the controller 40 ensure a specific load is delivered to a correct bin.

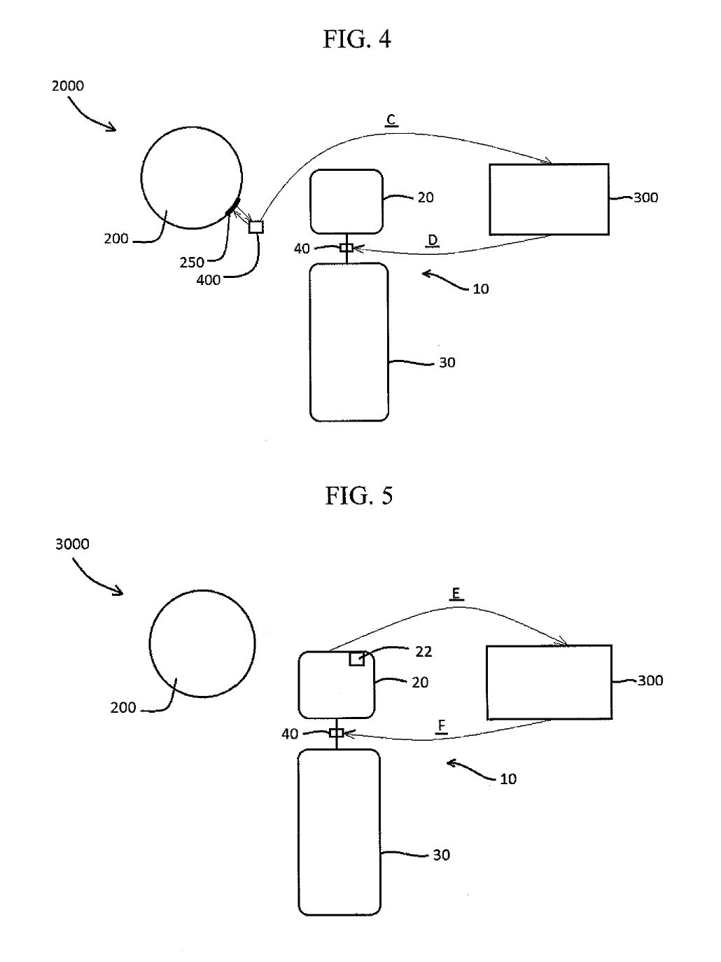

FIG. 4 is view of another system 2000 using the power system 10 in accordance with example embodiments. As shown in FIG. 4, the system 2000 includes the power source 20, the drain 30, and the power controller 40. As in the previous nonlimiting example, the power source 20 may be part of a tractor, the drain 30 may be part of a trailer, and the power controller 40 may be between the tractor and the trailer and may control power flowing from the tractor to the trailer. In example embodiments, the example system 2000 may further include a bin 200 and a management center 300. In example embodiments, the bin 200 may be, but is not limited to, a grain bin and the management center 300 may be, but is not limited to, a grain management center. In example embodiments, the management center 300 may include a computer system configured to receive and transmit a signal. For example, the management center 300 may be configured to send a signal to the power controller 40 to prevent (or allow) power from flowing from the power source 20 to the drain 30 and may, in the event the source and drain are disconnected one from the other, record the date, time and location when such disconnection occurred.

As in the previous example, the bin 200 may include an identification mark 250. In example embodiments, the mark 250 may be a bar code which may be read by a bar code reader 400. In example embodiments, the bar code reader 400 may be configured to read the mark 250 and send a signal C pertaining to the mark to the management center 300. Thus, in the system 2000, the bar code reader 400 may help eliminate human error regarding an identification of a bin. In example embodiments, the management center 300 may, depending on the information transmitted to it from the bar code reader 400, send a signal D to the controller 40 to at least one of allow power to be transmitted from the power source 20 to the drain 30 or prevent power from flowing from the power source 20 to the drain 30.

A particularly useful nonlimiting embodiment of the system 2000 may be employed at sites with multiple bins wherein a specific load is to be delivered to a specific bin (an example of the bin 200). In this particular nonlimiting example, a driver may drive a tractor/trailer (an example of a power source 20 and the drain 30) having a controller 40 therein to a site with the multiple bins. As in the previous example, data regarding the specific load, for example, a type, blend, or quality of grain, may be provided to a grain management system (an example of the management system 300) either before the specific load is loaded into the trailer, as the specific load is being loaded onto the trailer, or after the specific load is loaded onto the trailer. The grain management system or another user may then determine which bin the specific load is to be delivered to.

In this particular nonlimiting example, the driver may transport the specific load to the site having the multiple bins and arrange the tractor/trailer near a specific bin which the driver believes is the specific bin to which the specific load is to be unloaded (an example of the bin 200). The driver may then use a bar code reader to read a bar code present on the bin (an example of the identification mark 250) and the bar code reader may send a signal to the grain management center. The grain management center may then use that information to determine whether the driver is at the correct bin. If the driver is at the correct bin, the grain management center may send a signal to the controller 40 to allow power to flow from the tractor to equipment on the trailer (for example, motors, belts, and augers) to allow the driver to deliver the specific load to the identified bin. In the event the grain management center determines the driver is at the wrong bin, the grain management center may either send a signal to controller 40 to prevent power from flowing from the tractor to the equipment on the trailer to prevent the specific load from being placed in the incorrect bin or would not send a signal that enables power to be sent from the tractor to the trailer. In either case, the cooperation of the grain management center and the controller 40 ensure a specific load is delivered to a correct bin.

FIG. 5 is view of another system 3000 using the power system 10 in accordance with example embodiments. As shown in FIG. 5, the system 3000 includes the power source 20, the drain 30, and the power controller 40. As in the previous nonlimiting example, the power source 20 may be part of a tractor, the drain 30 may be part of a trailer, and the power controller 40 may be between the tractor and the trailer and may control power flowing from the tractor to the trailer. In example embodiments, the example system 3000 may further include a bin 200 and a management center 300. In example embodiments, the bin 200 may be, but is not limited to, a grain bin and the management center 300 may be, but is not limited to, a grain management center. In example embodiments, the management center 300 may include a computer system configured to receive and transmit a signal. For example, the management center 300 may be configured to send a signal to the power controller 40 to allow (or prevent) power from flowing from the power source 20 to the drain 30 or to receive a signal if the power source 20 and drain 30 are disconnected and record date, time and location of the controller.

Unlike the previous examples, the bin 200 may lack an identification mark 250. Instead, a position of the bin 200 may be recorded and stored by the management system 300. For example, the position of the bin 200 may be established by a global positioning satellite. In example embodiments, a global positioning device 22 may be attached to the power source 20. In example embodiments, a user, or the global positioning device 22, may send information regarding a position of the power source 20 to the management center 300 and the management center 300 may, depending on the coordinates of the power source 20, send a signal to the controller 40 to at least one of allow power to be transmitted from the power source 20 to the drain 30 or prevent power from flowing from the power source 20 to the drain 30.

A particularly useful nonlimiting embodiment of the system 3000 may be employed at sites with multiple bins wherein a specific load is to be delivered to a specific bin. In this particular nonlimiting example, a driver may drive a tractor/trailer (an example of a power source 20 and the drain 30) having a controller 40 therein to a site with the multiple bins. As in the previous example, data regarding the specific load, for example, a type, blend, or quality of grain, may be provided to a grain management system (an example of the management system 300) either before the specific load is loaded into the trailer, as the specific load is being loaded onto the trailer, or after the specific load is loaded onto the trailer. The grain management system or another user may then determine which bin the specific load is to be delivered to.

In this particular nonlimiting example, the driver may transport the specific load to the site having the multiple bins and arrange the tractor/trailer near a specific bin which the driver believes is the specific bin to which the specific load is to be unloaded (an example of the bin 200). The driver may then use the global positioning device 22, which may be arranged near the tractor/trailer, to transmit his position to the grain management center. The grain management center may then use that information to determine whether the driver is at the correct bin. If the driver is at the correct bin, the grain management center may send a signal to the controller 40 to allow power to flow from the tractor to equipment on the trailer (for example, motors, belts, and augers) to allow the driver to deliver the specific load to the identified bin. In the event the grain management center determines the driver is at the wrong bin, the grain management center may either send a signal to controller 40 to prevent power from flowing from the tractor to the equipment on the trailer to prevent the specific load from being placed in the incorrect bin or would not send a signal that enables power to be sent from the tractor to the trailer. In either case, the cooperation of the grain management center and the controller 40 ensure a specific load is delivered to a correct bin.

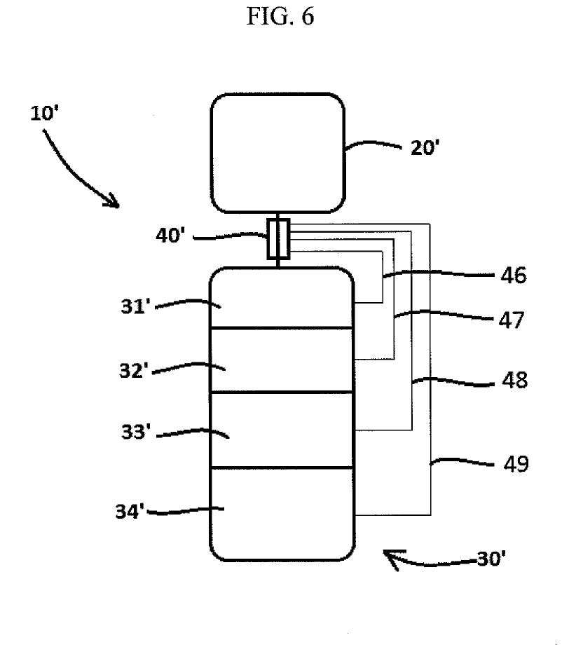

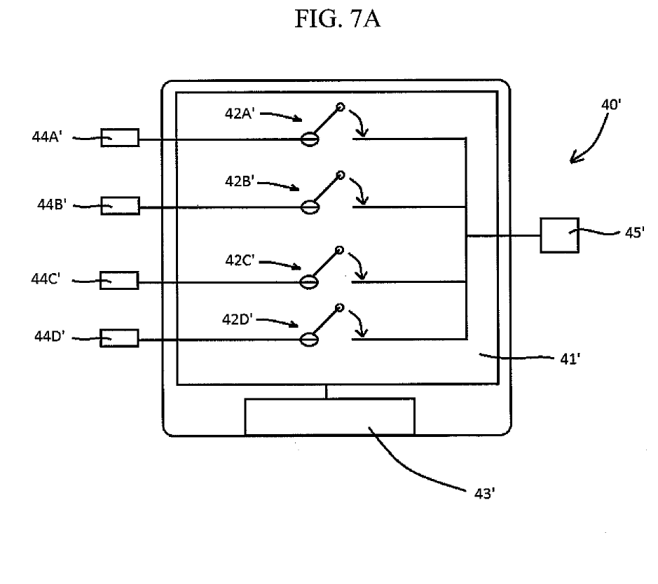

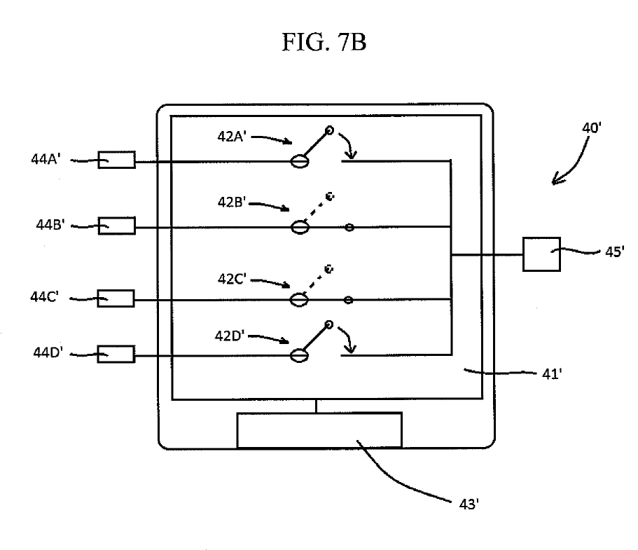

FIG. 6 is a view of a power system 10′ in accordance with example embodiments. The power system 10′ may include a source 20′, a drain 30′, and a controller 40′ configured to regulate power between the source 20′ and the drain 30′. In example embodiments, the source 20′ may be a vehicle, for example, a tractor, and the drain 30′ may be a trailer or equipment associated with the trailer. In example embodiments, the controller 40′ may be configured to control power flowing from the source 20′ to the drain 30′. In addition, the controller 40′ may include a receiver 43′ (see FIGS. 7A and 7B) configured to receive a signal from a transmitter. In example embodiments, the signal may be used to control power flowing from the source 20′ to the drain 30′.

In example embodiments, the drain 30′ may be a trailer having different compartments. For example, in FIG. 6, the drain 30′ is illustrated as a trailer having a first compartment 31′, a second compartment 32′, a third compartment 33′, and a fourth compartment 34′. Although FIG. 6 illustrates the drain 30′ as a trailer having four compartments, example embodiments are not limited thereto as the drain may be a trailer having more or less than four compartments. In example embodiments, the controller 40′ may be configured to receive a signal from a transmitter and regulate power to the first, second, third, and fourth compartments 31′, 32′, 33′, and 34′. For example, the controller 40′ may receive a signal that allows a user to control and release airgates or pneumatic compartment locks for one or more of the compartments.

FIGS. 7A and 7B illustrate a nonlimiting example of the controller 40′. As shown in FIGS. 7A and 7B, the controller 40′ may include a receiver 43′ configured to receive a signal from a transmitter. The receiver 43′ may be connected to a circuit 41′ that includes a plurality of switches 42A′, 42B′, 42C′, and 42D′. Although FIGS. 7A and 7B illustrate a controller 40′ having four switches, example embodiments are not limited thereto as there may be more or less than four switches. In example embodiments, the circuit 41′ may be processer which determines which of the switches 42A′, 42W, 42C′, and 42′D may be opened or closed depending on a signal received by the receiver 43′.

In example embodiments, the controller 40′ may include a first connector 44A′ connected to the first switch 42A′, a second connector 44B′ connected to the second switch 42W, a third connector 42C′ connected to the third switch 42C′, a fourth connector 44D′ connected to the fourth switch 42D′, and a fifth connector 45′. In example embodiments, the first, second, third, and fourth connectors 44A′, 44B′, 44C′, and 44D′ may connect to cables that provide power to various drains. For example, if the controller 40′ is used with the drain 30′ and the drain 30′ is a trailer having four compartments 31′, 32′, 33′, and 34′, the first, second, third, and fourth connectors 44A′, 44W, 44C′, and 44D′ may connect to the first, second, third, and fourth cables 46, 47, 48, and 49 that provide power to the four compartments 31′, 32′, 33′, and 34′, as shown in FIG. 6. In example embodiments, the fifth connector 45′ may connect to the power source 20′, for example, an electrical system of a vehicle, such as a tractor. Thus, the controller 40′ may control power to any one of the four compartments 31′, 32′, 33′, and 34′ based on a signal received by the receiver 43′. When a compartment contains material that would contaminate material in other compartments via use of the same drain, then the management center will control the order in which the compartments may be unloaded in order to avoid such contamination.

In example embodiments, each of the first, second, third, and fourth compartments 31′, 32′, 33′, and 34′ may store different materials. For example, the first compartment 31′ may store a feed product of a first blend, the second compartment 32′ may store a feed product of a second blend, the third compartment 33′ may store a feed product of a third blend, and the fourth compartment 34′ may store a feed product of a fourth blend. Alternatively, one of these compartments may include a medically treated feed product which must be unloaded last; in that example, the management center would not allow unloading of the medically treated load until the other loads had been unloaded first. The management center would provide the order of unloading to the driver. Example embodiments, however, are not limited thereto as a same blend of animal feed may be stored in at least two bins or all of the bins.

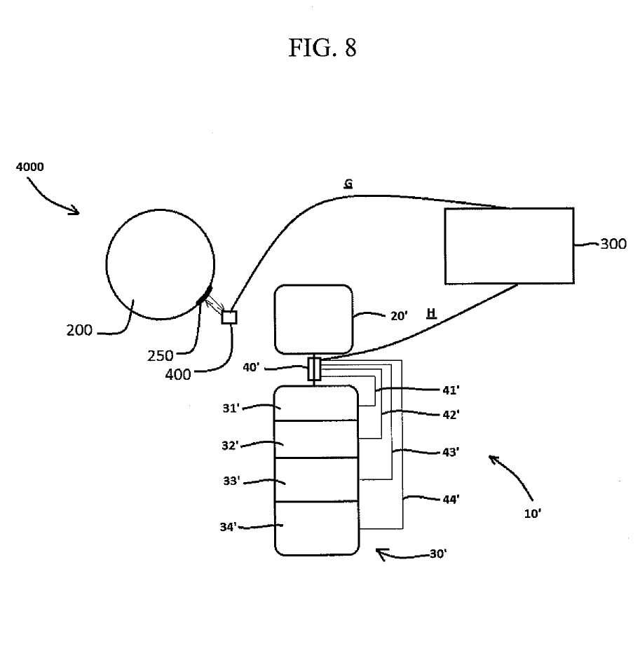

FIG. 8 is view of system 4000 using the power system 10′ in accordance with example embodiments. As shown in FIG. 7, the system 4000 includes the power source 20′, the drain 30′, and the power controller 40′. In example embodiments, the power source 20′ may be part of a tractor, the drain 30′ may be part of a multi-compartment trailer, and the power controller 40′ may be between the tractor and the multi-compartment trailer and may control power flowing from the tractor to the trailer. In example embodiments, the example system 4000 may further include a bin 200 and a management center 300. In example embodiments, the bin 200 may be, but is not limited to, a grain bin and the management center 300 may be, but is not limited to, a grain management center. In example embodiments, the management center 300 may include a computer system configured to receive and transmit a signal. For example, the management center 300 may be configured to send a signal to the power controller 40′ to prevent (or allow) power from flowing from the power source 20′ to the drain 30′.

As in the previous examples, the bin 200 may include an identification mark 250. In example embodiments, the mark 250 may be a bar code which may be read by a bar code reader 400. In example embodiments, the bar code reader 400 may be configured to read the mark 250 and send a signal G pertaining to the mark to the management center 300. Thus, in the system 4000, the bar code reader 400 may help eliminate human error regarding an identification of a bin. In example embodiments, the management center 300 may, depending on the information transmitted to it from the bar code reader 400, send a signal H to the controller 40′ to at least one of allow power to be transmitted from the power source 20′ to the drain 30′ or prevent power from flowing from the power source 20′ to the drain 30′.

A particularly useful nonlimiting embodiment of the system 4000 may be employed at sites with multiple bins. In this particular nonlimiting embodiment, different loads (for example, animal feeds with different blends) are loaded into a multicompartment trailer and each of the different loads are to be delivered to different, yet specific, bins at the site. In this particular nonlimiting example, a driver may drive a tractor/trailer (an example of the power source 20′ and the drain 30′) having the controller 40′ therein to a site with the multiple bins. As in the previous example, data regarding the specific loads in each compartment, for example, a type, blend, or quality of grain, may be provided to a grain management system (an example of the management system 300) either before the specific load is loaded into the trailer, as the specific load is being loaded onto the trailer, or after the specific load is loaded onto the trailer. The grain management system or another user may then determine which bin the specific load is to be delivered to.

In this particular nonlimiting example, the driver may transport the specific loads to the site having the multiple bins and arrange the tractor/trailer near a specific bin which the driver believes is a specific bin to which a specific load is to be unloaded. The driver may then use a bar code reader to read a bar code present on the bin (an example of the identification mark 250) and the bar code reader may send a signal to the grain management center. The grain management center may then use that information to determine whether the driver is at a correct bin. If the driver is at a correct bin, the grain management center may send a signal to the controller 40′ to allow power to flow from the tractor to one of more specific compartments of the trailer to power equipment associated with the one or more compartments (for example, motors, belts, and augers) to allow the driver to deliver the specific load(s) to the identified bin. In the event the grain management center determines the driver is at a wrong bin, the grain management center may either send a signal to controller 40′ to prevent power from flowing from the tractor to the equipment on the trailer to prevent the specific load from being placed in the incorrect bin or would not send a signal that enables power to be sent from the tractor to the trailer. In either case, the cooperation of the grain management center and the controller 40′ ensure a specific load is delivered to a correct bin.

In example embodiments, the various systems may be enabled by conventional technologies. For example, IEEE 802.11 is a set of standards for implementing wireless local area network (WLAN) computer communication in the 2.4, 3.6 and 5 GHz frequency bands. The IEEE 802.11 may be used to develop the wireless local area network to implement example embodiments. On the other hand, another nonlimiting example technology that may be used to enable example embodiments us Bluetooth technology. Bluetooth is a wireless technology standard for exchanging data over short distances (using short-wavelength radio transmissions in the ISM band from 2400-2480 MHz) from fixed and mobile devices, creating personal area networks (PANs) with high levels of security. Created by telecom vendor Ericsson in 1994,[1] it was originally conceived as a wireless alternative to RS-232 data cables. It can connect several devices, overcoming problems of synchronization. As yet another example of a conventional technology that may be used to enable example embodiments, are the the Global Positioning Systems (GPS) maintained by the United States government. This technology is freely accessible to anyone with a GPS receiver. This technology uses a space-based satellite navigation system that provides location and time information in all weather, anywhere on or near the Earth, where there is an unobstructed line of sight to four or more GPS satellites.

In example embodiments, the management center 300 is illustrated as being in a location remote from the power source 20, the drain 30, the controller 40, and the bin. In example embodiments, rather than being at a remote location, the management center 300 may be resident on a computer which may be associated with the power source 20. For example, in the event the power source 20 is a tractor and the drain is a trailer, the management center 300 may be a computer located in the tractor or the trailer. As yet another example, the management center may be a computer located at the bin 200.

While example embodiments have been particularly shown and described with reference to example embodiments thereof, it will be understood by those of ordinary skill in the art that various changes in form and details may be made therein without departing from the spirit and scope of the invention.

What we claim is:

1. A controller comprising:
a receiver configured to receive a signal from an external source; and
a circuit configured to regulate power flowing from a power source to a drain, wherein the circuit may prevent the power from flowing from the source to the drain or allow power to flow from the source to the drain based on the signal.

2. The controller of claim 1, wherein the controller includes a first socket configured to connect to the power source and a second socket configured to connect to the drain.

3. The controller of claim 2, wherein the first socket is configured to connect to an electrical system of a vehicle, and the second socket is a configured to connect to an electrical system of a trailer.

4. A system comprising:
a power source;
a drain;
a controller connecting the power source to the drain, the controller being configured to receive a signal which enables the controller to at least one of allow power to flow from the power source to drain and prevent power from flowing from the power source to the drain; and
a remote management center configured to send the signal to the controller.

5. The system of claim 4, wherein the power source is a vehicle and the drain is a trailer.

6. The system of claim 5, wherein the controller is connected to an electrical system of the vehicle and controls power flowing to equipment associated with the trailer

7. The system of claim 6, further comprising:
a bin with an identification mark, wherein the management center sends the signal to the controller based on the identification mark.

8. The system of claim 7, wherein the identification mark comprises at least one from the group consisting of a bar code, a radio frequency identification, and an electronically detectable identifier.

9. The system of claim 8, further comprising:
a bar code reader configured to read the bar code and send a signal to the management center.

10. The system of claim 6, further comprising:
a global positioning device configured to send a position to the remote management center.

11. The system of claim 7, wherein the management center is configured to send a signal to the controller based on the position.

12. A system comprising:
a transporting device including a vehicle, a trailer, and a controller configured to control power flowing from the vehicle to equipment associated with the trailer based on a signal transmitted from an external source.

13. A method of delivering a material, comprising:
arranging a transporting device near a bin, the transporting device including a vehicle, a trailer holding the material, and a controller configured to control power flowing from the vehicle to equipment associated with the trailer; and
transmitting a signal from an external device to the controller, wherein the controller controls the power flowing from the vehicle to the equipment based on the signal transmitted from the external device.

14. The method of claim 13, further comprising:
sending identifying information about the bin to the external device.

15. The method of claim 14 further comprising:
reading a bar code on the bin with a bar code reader, wherein sending identifying information about the bin to the external device includes sending bar code information to the external device.

16. The method of claim 13, further comprising:
sending positioning information associated with the transporting device to the external device.

17. The method of claim 13, further comprising:
operating the equipment associated with the trailer to unload the material.

18. The method of claim 13, wherein the material includes at least one of animal feed and grain.

19. The method of claim 13, wherein the external device is associated with a grain management system.

20. The method of claim 13, wherein said trailer holding the material comprises a plurality of compartments, and based on said signal, said external device controls the order in which each said compartment is unloaded.

21. The method of claim 19 wherein said external device is associated with the grain management system via one from the group consisting of: Bluetooth, 80211, cellular phone.
